(19) United States
(12) Patent Application Publication
(10) Pub. No.: US 2025/0162327 A1
(43) Pub. Date: May 22, 2025

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventors: HIROSHI KAWAFUJI, Tokyo (JP); TAKAYOSHI KIKUCHI, Kanagawa (JP); DAISUKE YOSHITOKU, Kanagawa (JP); SHUNSUKE KAKEI, Kanagawa (JP); NAOKO BABA, Kanagawa (JP); YOSHIYUKI HONDA, Kanagawa (JP); AKIHIRO MOURI, Tokyo (JP); SATOSHI AZUMA, Tokyo (JP)

(21) Appl. No.: 18/949,034

(22) Filed: Nov. 15, 2024

(30) Foreign Application Priority Data
Nov. 16, 2023 (JP) 2023-195293

(51) Int. Cl. B41J 2/505; B41J 2/51; B41J 3/01; G06K 15/10

(52) U.S. Cl. CPC B41J 2/5052; B41J 2/5056; B41J 2/51; G06K 15/102; B41J 3/01

(57) ABSTRACT

An image processing apparatus for correcting image data used to print an image on a print medium by discharging ink from a plurality of nozzles provided in a printhead in scanning in each of a first direction included in a scanning direction crossing a conveyance direction of the print medium and a second direction different from the first direction, comprising a correction unit configured to perform correction for, in the image data, image data to be printed by scanning in the first direction in accordance with a degree of condensing of the ink in the nozzles such that a density change caused by the condensing is relaxed, and perform, for image data to be printed by scanning in the second direction in the image data, correction different from the correction for the image data to be printed by the scanning in the first direction.

### BACKGROUND OF THE INVENTION

### Field of the Invention

The present disclosure relates to an image processing apparatus, an image processing method, and a non-transitory computer-readable storage medium.

### Description of the Related Art

In an inkjet printhead including a plurality of nozzles that discharge ink, the ink is discharged from the plurality of nozzles in accordance with print data, thereby forming an image on a print medium. In such a printhead, the discharge frequency of the nozzles varies in accordance with the image to be printed. In a state in which the discharge frequency is low, the volatile component of the ink in orifices evaporates, and condensing of ink progresses. If the ink in the nozzles condenses, the color material concentration per discharge amount increases, and as a result, the image density expressed on the print medium is increased more than necessary.

Japanese Patent Laid-Open No.2016-215571 discloses a method of predicting discharge or non-discharge for each nozzle based on multi-valued data before quantization, estimating the ink condensing level of each nozzle based on this, and correcting the multi-valued data. When Japanese Patent Laid-Open No.2016-215571 is employed, even if the discharge count is low, and an increase of the ink concentration occurs, substantially the same image density as an image printed by ink without a concentration increase can be implemented.

### SUMMARY OF THE INVENTION

According to one aspect of the present disclosure, there is provided an image processing apparatus for correcting image data used to print an image on a print medium by discharging ink from a plurality of nozzles provided in a printhead in scanning in each of a first direction included in a scanning direction crossing a conveyance direction of the print medium and a second direction different from the first direction, comprising a correction unit configured to perform correction for, in the image data, image data to be printed by scanning in the first direction in accordance with a degree of condensing of the ink in the nozzles such that a density change caused by the condensing is relaxed, and perform, for image data to be printed by scanning in the second direction in the image data, correction different from the correction for the image data to be printed by the scanning in the first direction.

According to another aspect of the present disclosure, there is provided an image processing method of correcting image data used to print an image on a print medium by discharging ink from a plurality of nozzles provided in a printhead in scanning in each of a first direction included in a scanning direction crossing a conveyance direction of the print medium and a second direction different from the first direction, comprising performing correction for, in the image data, image data to be printed by scanning in the first direction in accordance with a degree of condensing of the ink in the nozzles such that a density change caused by the condensing is relaxed, and performing, for image data to be printed by scanning in the second direction in the image data, correction different from the correction for the image data to be printed by the scanning in the first direction.

According to another aspect of the present disclosure, there is provided a non-transitory computer-readable storage medium storing a computer program that, when read and executed by a computer for correcting image data used to print an image on a print medium by discharging ink from a plurality of nozzles provided in a printhead in scanning in each of a first direction included in a scanning direction crossing a conveyance direction of the print medium and a second direction different from the first direction, causes the computer to function as a correction unit configured to perform correction for, in the image data, image data to be printed by scanning in the first direction in accordance with a degree of condensing of the ink in the nozzles such that a density change caused by the condensing is relaxed, and perform, for image data to be printed by scanning in the second direction in the image data, correction different from the correction for the image data to be printed by the scanning in the first direction.

Further features of the present disclosure will become apparent from the following description of exemplary embodiments (with reference to the attached drawings).

### BRIEF DESCRIPTION OF THE DRAWINGS

FIG. 1 is a block diagram for explaining the control configuration of an inkjet printing apparatus;

FIG. 2 is a block diagram for explaining processing executed by an image data processing unit;

FIG. 3A is a view showing the overall configuration of a print processing unit;

FIG. 3B is a view showing a printhead viewed obliquely from a lower side;

FIG. 4 is a view for explaining the order of pixels to be processed by the image data processing unit;

FIG. 5 is a view showing an image of one band in a prior art, the degree of ink condensing, multi-valued density data after correction, and the density of a printing result of an image;

FIG. 6 is a view for explaining a case where an image is printed in a backward direction using the same image data as in FIG. 5;

FIG. 7 is a view for explaining a case where an image is printed in a backward direction using the same image data as in FIG. 5 in an embodiment;

FIG. 8 is a block diagram for explaining the function of a density correction processing unit according to the first embodiment;

FIG. 9A is a flowchart showing correction processing of multi-valued density data according to the first embodiment;

FIG. 9B is a flowchart for explaining updating processing of a condensing level parameter based on multi-valued density data after correction according to the first embodiment;

FIG. 10 is a view showing the reversing position of a printhead according to the second embodiment;

FIG. 11A is a flowchart showing correction processing of multi-valued density data according to the second embodiment;

FIG. 11B is a flowchart showing change processing of multi-valued density data and updating processing of a condensing level parameter according to the second embodiment;

FIG. 12A is a view showing a print medium in full width in a state in which an image including a plurality of bands is printed in a case where the image is reversed at the two end portions of the print medium in a scanning direction according to the second embodiment;

FIG. 12B is a view showing the range of a band shown in FIG. 12A, which is cut out in the full width of the print medium;

FIG. 12C is a view showing the range in FIG. 12B, which is reversed in a left-and-right direction;

FIG. 13A is a view showing a case where the image is inverted in accordance with a scanning range according to the second embodiment;

FIG. 13B is a view showing a band 1301 in FIG. 13A, which is cut out in the full width of the scanning range;

FIG. 13C is a view showing the range in FIG. 13B, which is reversed in a left-and-right direction;

FIG. 14A is a view showing printing of an image by first print scanning in both two passes according to the third embodiment; and

FIG. 14B is a view showing printing of an image by second print scanning in both two passes according to the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Recently, in a serial type inkjet printing apparatus, image data is generally printed in two directions, that is, in a forward direction and a backward direction from the viewpoint of improving the printing speed. In patent literate 1, however, correspondence between the direction of correction processing of multi-valued data and the scanning direction of a printhead is not described.

In the above-described bidirectional printing, if the scanning direction of the printhead and the direction of correction processing of multi-valued data do not match, the multi-valued image data is corrected estimating that the condensing state is different from the actual ink condensing state and, therefore, the multi-valued condensing data cannot appropriately be corrected.

The present invention has been made in consideration of the above-described problem, and appropriately corrects print data in consideration of the condensing level of ink at the time of bidirectional printing.

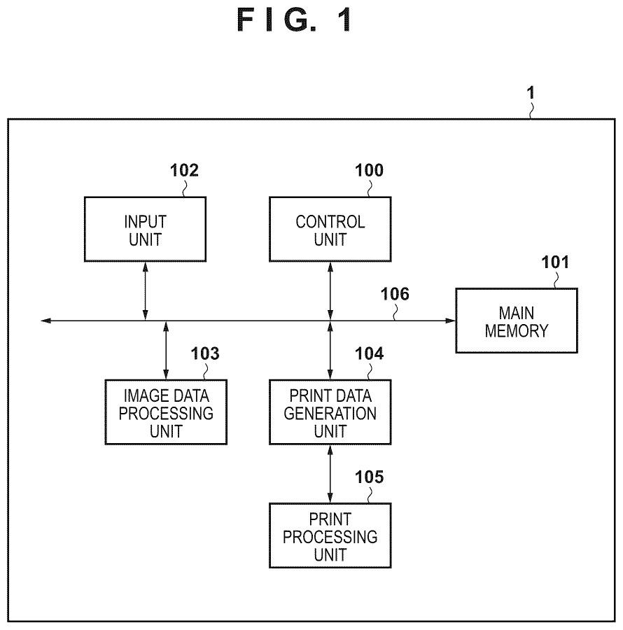

FIG. 1 is a block diagram for explaining the control configuration of an inkjet printing apparatus 1 usable as an image processing apparatus according to the embodiment. The control configuration of the inkjet printing apparatus 1 is, for example, a computer, and includes a control unit 100, a main memory 101, an input unit 102, an image data processing unit 103, a print data generation unit 104, a print processing unit 105, and a data bus 106. Multi-valued image data input from the input unit 102 is temporarily stored in the main memory 101 including, for example, a volatile Random Access Memory (RAM) via the data bus 106. After that, the image data processing unit 103 reads out the pixels of the image data one by one in accordance with a predetermined order, converts the multi-valued image data into binary data indicating printing (1) or non-printing (0) by performing predetermined image processing, and then stores the image data in the main memory 101 again. The print data generation unit 104 reads out the binary data stored in the main memory 101 in a predetermined order, and provides it to the print processing unit 105 in association with each nozzle of a printhead used by the printing apparatus. The print processing unit 105 includes a printhead 303 in which nozzle arrays each including a plurality of nozzles for discharging ink as droplets are arranged as many as the number of ink colors, and a conveyance unit 304 that executes a conveyance operation for a print medium such as paper. Using the printhead and the conveyance means, the print processing unit 105 prints an image on the print medium in accordance with print data received from the print data generation unit 104. Some or all of the functions of the image data processing unit 103, the print data generation unit 104, and the print processing unit 105 may be implemented as the function of a processor that has loaded a program, and may be implemented by a circuit such as an Application Specific Integrated Circuit (ASIC) or a Field Programmable Gate Array (FPGA). Note that in the following description, the term “image” is sometimes a concept including an image or image data.

The control unit 100 generally controls the entire inkjet printing apparatus 1 including the above-described plurality of processing units. The control unit 100 includes a processor. For example, the control unit 100 includes a Central Processing Unit (CPU). Note that the control unit 100 may include a Graphics Processing Unit (GPU), a Micro Processing Unit (MPU), a Quantum Processing Unit (QPU), or the like in place of or in addition to the CPU. The inkjet printing apparatus 1 may include a storage such as a Hard Disk Drive (HDD) or a Solid State Drive (SSD).

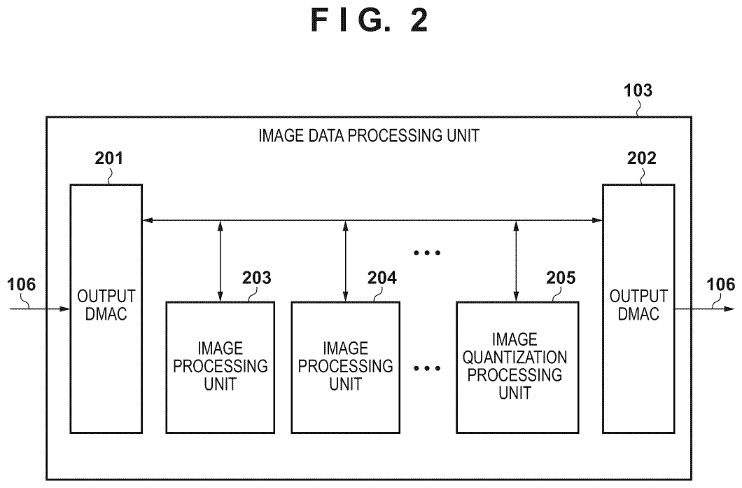

FIG. 2 is a block diagram for explaining processing executed by the image data processing unit 103 in detail. Image data including multi-valued density data stored in the main memory 101 is first input to an input DMAC 201 via the data bus 106. After that, modularized image processes such as image processing by an image processing unit 203 and image processing by an image processing unit 204 are performed sequentially for the image data. Finally, a quantization processing unit 205 executes quantization processing for the image data, and the image data is then output from an output DMAC 202. Characteristic processing according to this embodiment, that is, correction processing for correcting multi-valued density data in association with condensing of ink is performed on one module, like the image processing unit 203 or the image processing unit 204, in a stage before quantization processing, that is, in the stage of multi-valued density data. That is, processing is completed as one independent module without using data after quantization. The image processing units 203 and 204 and the quantization processing unit 205 may be implemented as the function of a processor that has loaded a program, and may be implemented by a circuit such as an Application Specific Integrated Circuit (ASIC) or a Field Programmable Gate Array (FPGA). Note that DMAC is short for Direct Memory Access Controller.

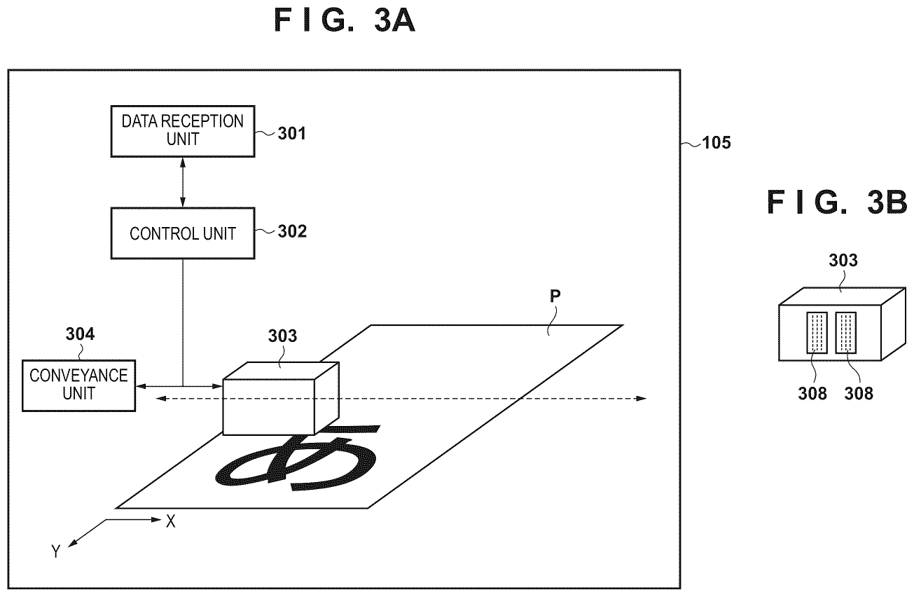

FIGS. 3A and 3B are views for explaining printing of an image in the print processing unit 105. FIG. 3A is a view showing the overall configuration of the print processing unit 105. FIG. 3B is a view showing a printhead viewed obliquely from a lower side. In FIG. 3A, the +X direction is the right direction, and the −X direction is the left direction.

Print data generated by the print data generation unit 104 is provided to the control unit 302 via a data reception unit 301. The control unit 302 controls the printhead 303 and the conveyance unit 304, thereby printing an image based on the print data on a print medium P. In the printhead 303, nozzle arrays 308 formed by arraying M nozzles for discharging ink as droplets are arranged as many as the number of ink colors. In the inkjet printing apparatus according to this embodiment, print scanning in which the printhead 303 moves in the X direction crossing the nozzle array direction while discharging ink from the nozzle arrays 308 and a conveyance operation of conveying the print medium P in the Y direction by a distance corresponding to the printing width of print scanning are alternately repeated, thereby printing the image. Note that the X direction in which the printhead 303 scans will also be referred to as a scanning direction or a left-and-right direction. The Y direction in which the print medium P is conveyed will also be referred to as a conveyance direction. The scanning direction and the conveyance direction cross each other, for example, are orthogonal to each other.

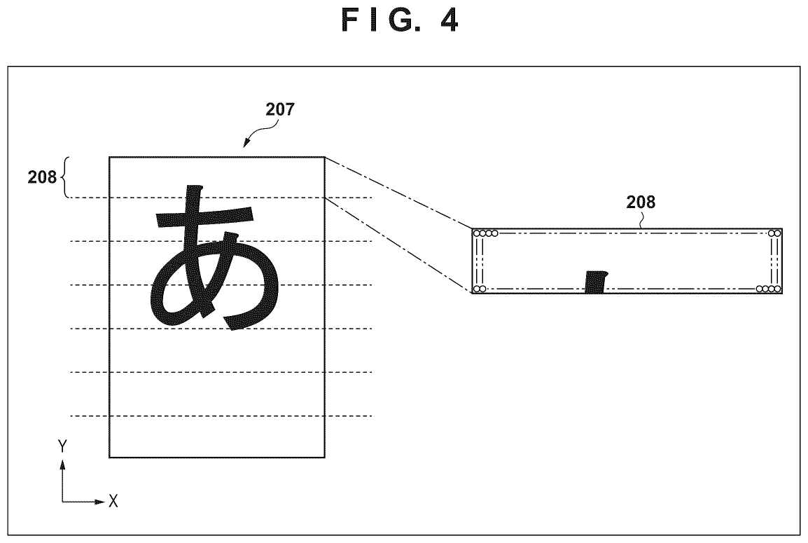

FIG. 4 is a view for explaining the order of pixels to be processed by the image data processing unit 103 to support the printing method described with reference to FIG. 3. An image 207 of image data of one page input by the input unit 102 and stored in the main memory 101 is managed using, as a unit of processing, a band 208 corresponding to one print scanning by the printhead 303 in the X direction. One print scanning corresponds to, for example, a section from the start of scanning of the printhead 303 in one band 208 to reversal. A pixel region corresponding to one band 208 includes a Y-direction region (raster) corresponding to M that is the number of nozzles arrayed in the printhead 303 along the Y direction and a X-direction region (column) printable by one print scanning. As shown in FIG. 4, the input DMAC 201 receives, for one column, M pixels one by one in an order from the +Y direction to the −Y direction, and if this is ended, for a column adjacent to the column in the +X direction, similarly receives M pixels in the order from the +Y direction to the −Y direction. In each module from the image processing unit 203 to the quantization processing unit 205 as well, processing for each pixel is performed in the cross-band order. However, the embodiment is not limited to this. For example, the size of the band 208 in the Y direction may be a unit smaller than the number M of nozzles. Alternatively, processing of each module may be performed for a unit of a plurality of pixels while maintaining the cross-band state.

### First Embodiment

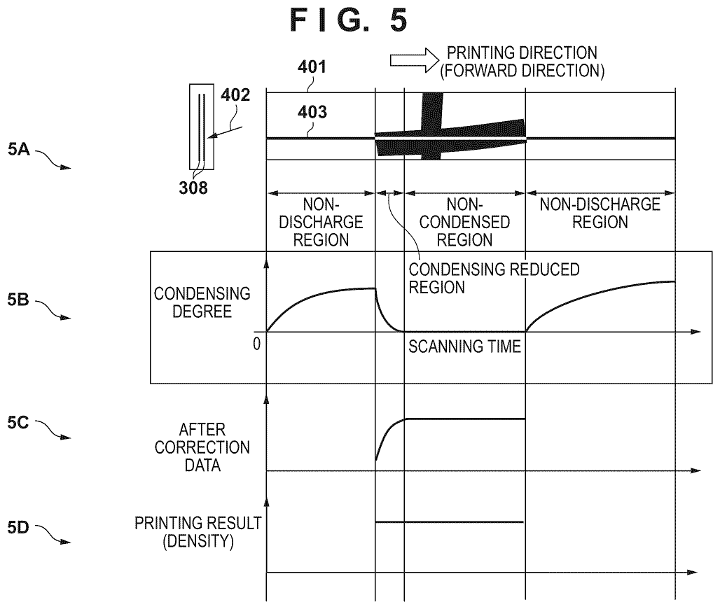

In FIG. 5, 5A to 5D are views for explaining an image 401 of one band printed on a print medium by one print scanning of the printhead 303, the degree of ink condensing, multi-valued density data after correction, and the density of a printing result of the image. In FIG. 5, 5A shows the actual image 401 printed on the print medium in accordance with image data corresponding to the first band 208 of the image shown in FIG. 4. In FIG. 5, 5B shows a state in which the degree of ink condensing changes over time focusing a nozzle 402 corresponding to one line 403 in the image 401. Here, a state in which a standard concentration is implemented is indicated as a condensing level “0”. Also, in 5A of FIG. 5, the region of the line 403 printed by the nozzle 402 is shown by black and white inversion for the sake of discrimination from lines on the periphery.

Immediately before the start of print scanning, preliminary discharge independent of image data is performed, and a predetermined number of ink droplets are discharged from all nozzles. The preliminary discharge is performed by, for example, discharging ink outside the print medium. By the preliminary discharge, the condensing level in the nozzle 402 is 0 (that is, the standard concentration) immediately after the start of print scanning. After that, the printhead 303 discharges ink in accordance with the image data while scanning in the X direction. Here, as shown in 5A of FIG. 5, a non-discharge region continues for a while in the line 403. For this reason, water in the nozzle 402 gradually evaporates from the orifice, and the condensing level of the ink increases. When the non-discharge region ends, and the discharge region starts, the condensed ink is discharged in accordance with the discharge operation of the nozzle 402, and the condensing level lowers to 0. In the example shown in 5A of FIG. 5, the discharge region continues for a while even after the condensing level lowers to 0, and the ink of the standard concentration is maintained. After that, if the non-discharge region starts again, the condensing level in the nozzle 402 increases again due to evaporation of water.

As described above, the condensing level of ink depends on the discharge history of the nozzle. In other words, the degree of condensing in the nozzle 402 can be estimated to some extent based on the print data corresponding to the nozzle 402. For example, even if preliminary discharge immediately before the start of print scanning is not performed, if the ink condensing level in the immediately preceding print scanning is known, the condensing level after that can be estimated based on this.

In FIG. 5, 5C shows multi-valued density data corrected from the estimated condensing level. When the multi-valued density data to be input is changed to a shape obtained by inverting the condensing curve in the up-and-down direction in consideration of the amount of condensing in the non-discharge region, it is possible to obtain substantially the same image printing result as in a case where ink condensing does not exist, as shown in 5C of FIG. 5.

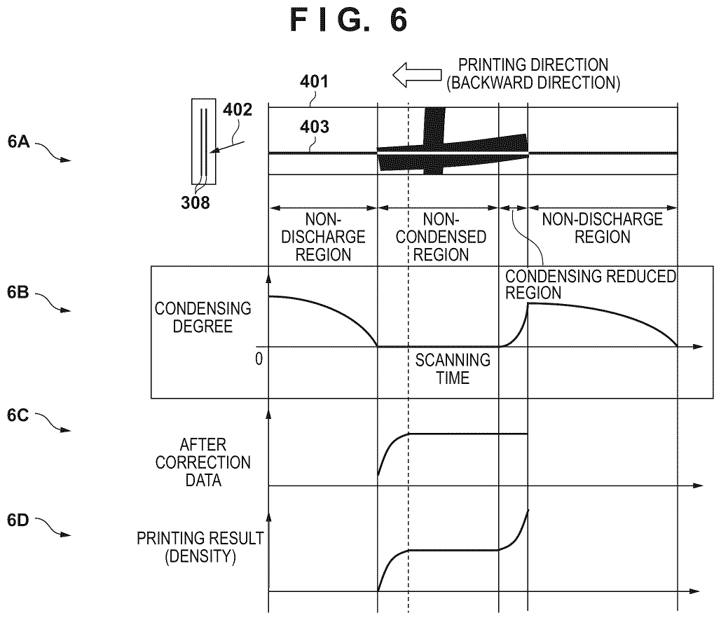

Here, FIG. 6 shows the degree of ink condensing, and the like in a case where the image is printed in the backward direction based on the same image data as in FIG. 5. As is apparent from FIG. 6, since printing of the image is started from the right side of the print medium, as compared to FIG. 5 in which printing of the image data is started from the left side of the print medium, the graph of the condensing level has a shape obtained by reversing the graph of the condensing level in 5B of FIG. 5 in the left-and-right direction. That is, the state of the ink condensing level changes between printing in the forward direction and printing in the backward direction. For this reason, as shown in 6C and 6D of FIG. 6, if density correction processing is performed in the same direction as in printing in the forward direction, the image printing result greatly deviates from that in a case where ink condensing does not exist. Note that the forward direction and the backward direction are examples of a first direction and a second direction different from the first direction.

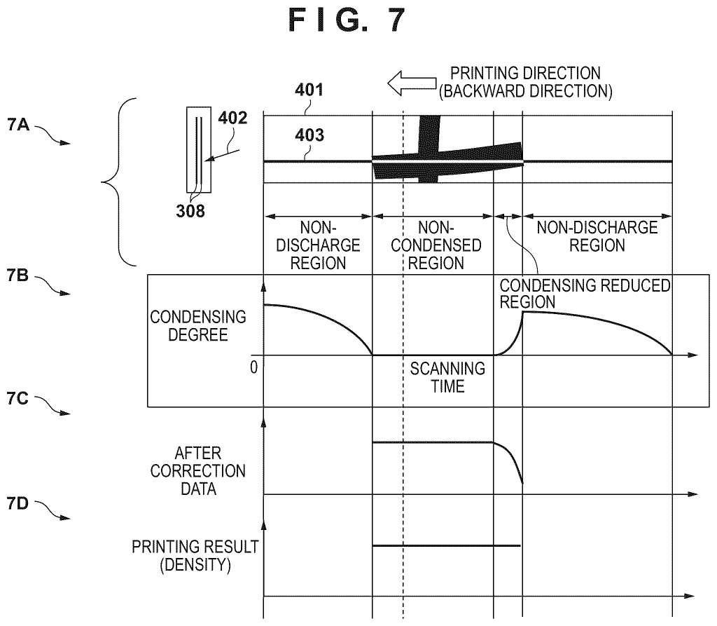

FIG. 7 is a view for explaining a case where the image is printed in the backward direction based on the same image data as in FIG. 5 according to the embodiment. In FIG. 7, 7C shows multi-valued density data after correction according to the ink condensing state at the time of image printing in the backward direction according to this embodiment. In 6C of FIG. 6, the multi-valued density data is corrected using the same ink condensing data as in image printing in the forward direction shown in FIG. 5. However, as is apparent from 7C of FIG. 7, the multi-valued density data is corrected in accordance with the ink condensing state in image printing in the backward direction.

As described above, in estimation of the ink condensing level and correction of the multi-valued density data, the density of the image cannot appropriately be corrected unless the correction is performed while grasping the printing direction of the image. Not only that, if the printing direction of the image and the processing direction of ink condensing level estimation and multi-valued density data correction are opposite to each other, data that is corrected in a direction reverse to the original correction direction appears, and the image printing result deteriorates as compared to a case where correction is not performed.

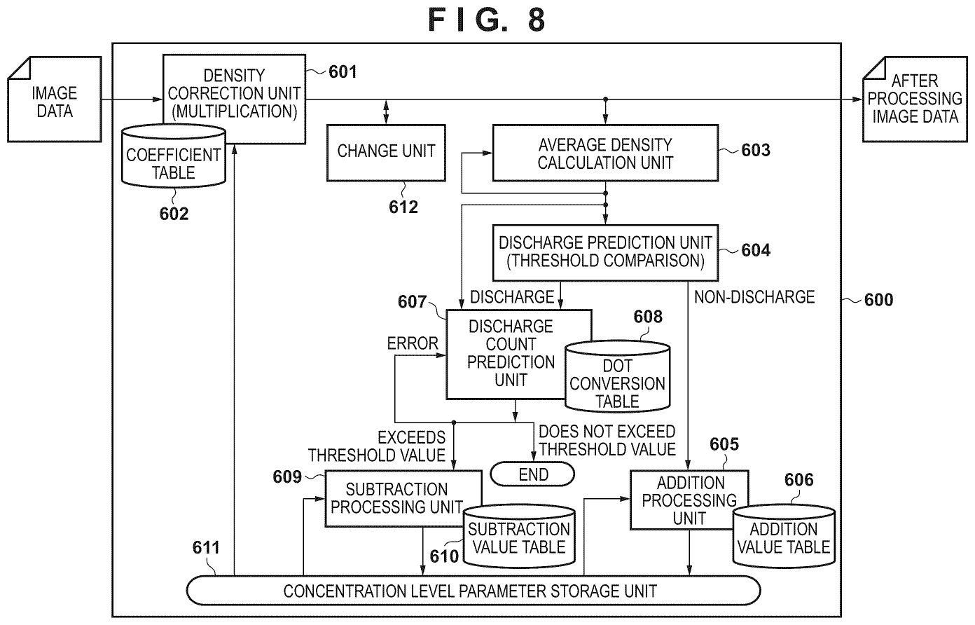

FIG. 8 is a block diagram for explaining the arrangement of a density correction processing unit according to this embodiment. In this embodiment, a density correction processing unit 600 can be considered as one module like an image processing unit 203 or an image processing unit 204 in an image data processing unit 103 shown in FIG. 2.

Image data input to the density correction processing unit 600 correspond to ink colors C (cyan), M (magenta), Y (yellow), and K (key plate), and density correction processing is performed for each plane, that is, for each ink color independently and parallelly. The image data of each color is multi-valued density data expressed by 8-bit 256 tones. The higher a data value held by a pixel of interest is, the higher the density of the pixel is. The multi-valued density data of the pixels are input one by one in the cross-band order described with reference to FIG. 4, subjected to predetermined density correction processing by a density correction unit 601, and then output to the next module.

A concentration level parameter storage unit 611 is a memory that manages a condensing level parameter indicating the degree of ink condensing in a nozzle array 308 at the current time. The density correction unit 601 acquires a condensing level parameter at the current time from the concentration level parameter storage unit 611, and performs correction processing for the input multi-valued density data based on this. A change unit 612 is a mechanism that changes the order of multi-valued density data after correction, which is used to correct the condensing level parameter in accordance with the printing direction of the image. The change unit 612, an average density calculation unit 603, a discharge prediction unit 604, a discharge count prediction unit 607, an addition processing unit 605, and a subtraction processing unit 609 are mechanisms configured to update the condensing level parameter of a corresponding nozzle based on the multi-valued density data after correction, which is output from the density correction unit 601, and are examples of updating means. A coefficient table 602, an addition value table 606, a dot conversion table 608, and a subtraction value table 610 are tables including data for updating the condensing level parameter of the nozzle.

The density correction processing unit 600 may be implemented as a function of a control unit 100. Some or all of the functions of the density correction unit 601, the change unit 612, the average density calculation unit 603, the discharge prediction unit 604, the addition processing unit 605, the discharge count prediction unit 607, and the subtraction processing unit 609, which are the functions of the density correction processing unit 600, may be implemented as the functions of a processor that has loaded a program, and may be implemented by a circuit such as an ASIC or an FPGA.

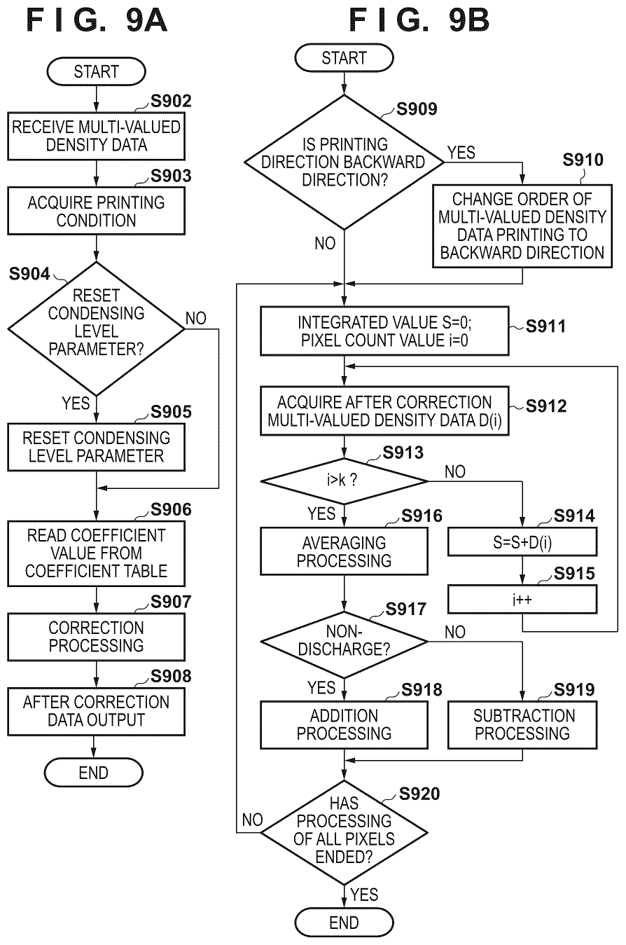

FIG. 9A is a flowchart for explaining multi-valued density data correction processing executed by the density correction unit 601. FIG. 9B is a flowchart for explaining updating processing of a condensing level parameter based on multi-valued density data after correction. The steps of the processing will be described below in detail in accordance with the flowcharts of FIGS. 9A and 9B while referring to the block diagram of FIG. 8. The flowcharts of FIGS. 9A and 9B are executed, for example, for each band, that is, for each processing unit, and repeated up to the end portion on the end side of an image in the conveyance direction. These flowcharts are substantially executed by the control unit 100 provided in an inkjet printing apparatus. Note that these flowcharts may be executed by one or some of the control unit 100, an image data processing unit 103, a print data generation unit 104, and a print processing unit 105. If multi-valued density data correction processing shown in FIG. 9A is

started, in step S902, the control unit 100 receives multi-valued density data using the density correction unit 601 and advances to step S903. The received multi-valued density data is an example of first multi-valued density data.

In step S903, using the density correction unit 601, the control unit 100 acquires a printing condition that is a condition when printing the target multi-valued density data by the inkjet printing apparatus. For example, the printing condition includes information indicating whether the printing direction is the forward direction or the backward direction.

In step S904, using the density correction unit 601, the control unit 100 determines whether to reset the condensing level parameter stored in the concentration level parameter storage unit 611 at the current time. For example, if maintenance processing such as preliminary discharge or suction processing for the printhead is performed immediately before, it can be considered that ink in the nozzles of the printhead has the standard concentration. Hence, the density correction unit 601 may determine whether, for example, preliminary discharge is executed, and may determine, based on the determination result, whether to reset the condensing level parameter. More specifically, upon determining that preliminary discharge is executed, the density correction unit 601 determines to reset the condensing level parameter. In this case, in step S905, the density correction unit 601 resets the condensing level parameter stored in the concentration level parameter storage unit 611, and advances to step S906. On the other hand, upon determining that preliminary discharge is not executed, the density correction unit 601 determines not to reset the condensing level parameter, and advances to step S906 without resetting the condensing level parameter.

In step S906, using the density correction unit 601, the control unit 100 selects, from a plurality of coefficients stored in the coefficient table 602, one coefficient corresponding to the condensing level parameter stored in the concentration level parameter storage unit 611, and causes the density correction unit 601 to load it. The coefficient table 602 is a table in which condensing level parameters and coefficients are associated. In the coefficient table 602, the region of the condensing level parameters is divided into 16 regions each including 2048 parameters. The coefficients have values of 640 to 1,024, and each coefficient is formed by 11 bits.

In step S907, using the density correction unit 601, the control unit 100 executes predetermined correction processing for the received multi-valued density data using the coefficient loaded in step S906 and the printing condition acquired in step S903. The multi-valued density data after correction is an example of second multi-valued density data. The method of correcting multi-valued density data is not particularly limited, and here, the multi-valued density data is multiplied by the coefficient acquired in step S906, and division processing (that it, a 10-bit right shift operation) using a constant (=1,024) is executed.

In step S908, using the density correction unit 601, the control unit 100 outputs the obtained multi-valued density data after correction to the next module. This processing is thus ended.

Change processing of multi-valued density data and updating processing of a condensing level parameter will be described next with reference to FIG. 9B. This processing is started at a timing when the multi-valued density data after correction is output from the density correction unit 601 for the first time.

In the change processing of the multi-valued density data, in step S909, using the change unit 612, the control unit 100 determines, based on the printing condition acquired in step S903, whether the printing direction of printing the target multi-valued density data is the backward direction. Upon determining that the printing direction is the backward direction, the control unit 100 advances to step S910. Upon determining that the printing direction is not the backward direction, the control unit 100 advances to step S911 without executing step S910.

In step S910, using the change unit 612, the control unit 100 changes the printing order of the multi-valued density data after correction for a processing target row in accordance with the backward direction of the printing direction. For example, if an image is printed from left to right in the forward direction, the control unit 100 reverses and thus changes the printing order of the multi-valued density data such that the image is printed from right to left in the backward direction. In other words, the control unit 100 changes the order of printing by reversing the multi-valued density data to be used for correction in the left-and-right direction in accordance with the printing direction of each row.

In the updating processing of the condensing level parameter, in step S911, using the average density calculation unit 603, the control unit 100 first performs initialization processing of the parameter to be used. More specifically, the control unit 100 sets an integrated value S of the multi-valued density data after correction and a pixel count value i that is a parameter used to count the number of positions to 0.

Next, in step S912, using the average density calculation unit 603, the control unit 100 acquires multi-valued density data D(i) after correction corresponding to one pixel. Also, in step S912, it is determined whether i>K. Here, K represents the number of pixels forming one unit to perform the processing. In this embodiment, K equals the number M of nozzles included in the nozzle array 308 (K=M).

In step S913, using the average density calculation unit 603, upon determining that i>K does not hold, the control unit 100 advances to step S914, and adds the multi-valued density data D(i) after correction, which is acquired in step S912, to the integrated value S (S=S+D(i)). After the parameter i is incremented in step S915, the process returns to step S912 to acquire the multi-valued density data after correction for the next pixel.

On the other hand, in step S913, using the average density calculation unit 603, upon determining that i>K, the control unit 100 advances to step S916 to perform averaging processing because multi-valued density data after correction, which are necessary for averaging processing, are integrated as many as K pixels. For example, the average density calculation unit 603 may calculate the averaged data of the multi-valued density data by dividing the integrated multi-valued density data by the integration count. Using the average density calculation unit 603, the control unit 100 inputs the averaged data calculated in step S916 to the discharge prediction unit 604.

In step S917, using the discharge prediction unit 604, the control unit 100 determines whether the K-pixel region that is the target of averaging is “non-discharge” in which ink is not discharged, and generates a determination result. More specifically, the discharge prediction unit 604 compares the averaged data calculated in step S916 with a threshold. If the averaged data is a value larger than the threshold, the discharge prediction unit 604 determines that the region is “discharge” in which ink is discharged. If the averaged data is a value equal to or smaller than the threshold, the discharge prediction unit 604 determines that the region is “non-discharge”, and generates a determination result. At this time, “non-discharge” means that it is predicted that the discharge operation is not to be performed for any one of the K pixels as the target of averaging in quantization processing later.

If the discharge prediction unit 604 determines “non-discharge”, the control unit 100 advances to step S918 and executes addition processing. More specifically, the control unit 100 causes the discharge prediction unit 604 to transmit a signal indicating “non-discharge” to the addition processing unit 605. The control unit 100 causes the addition processing unit 605 activated by the signal to execute addition processing in a direction to make the condensing level parameter large. The addition processing unit 605 adds an addition value indicated by the addition value table 606 to the condensing level parameter.

On the other hand, if the discharge prediction unit 604 determines “discharge” in step S917, the control unit 100 advances to step S919 and executes subtraction processing. In the subtraction processing of step S919, the control unit 100 causes the discharge prediction unit 604 to transmit a signal indicating “discharge” to the subtraction processing unit 609. The control unit 100 causes the subtraction processing unit 609 activated by the signal to execute subtraction processing in a direction to make the condensing level parameter small. The subtraction processing unit 609 subtracts a subtraction value indicated by the subtraction value table 610 from the condensing level parameter. Note that the discharge prediction unit 604 may transmit a signal indicating “discharge” to the discharge count prediction unit 607. In this case, the discharge count prediction unit 607 converts the averaged data calculated in step S916 into a discharge count and compares the discharge count with a predetermined count threshold. The discharge count prediction unit 607 may acquire, for example, a discharge count associated with the averaged data, which is calculated from the dot conversion table 608 in which averaged data and discharge counts are associated. If the discharge count is a value larger than the threshold, the discharge count prediction unit 607 determines to execute subtraction processing. If the discharge count is equal to or smaller than the threshold, the discharge count prediction unit 607 determines not to execute subtraction processing. If the discharge count prediction unit 607 determines to execute subtraction processing, the subtraction processing unit 609 subtracts a subtraction value indicated by the subtraction value table 610 from the condensing level parameter.

If the addition processing of step S918 or the subtraction processing of step S919 is ended, the control unit 100 advances to step S920 and determines whether the processing is completed for the multi-valued density data of all pixels included in the image data of the processing unit. Upon determining that a pixel to be processed still remains, the process is returned to step S911 to perform correction processing for the next K pixels. On the other hand, upon determining that the processing is completed for all pixels, the processing is temporarily ended. After that, the control unit 100 executes the correction processing, the change processing, and the updating processing shown in FIGS. 9A and 9B for the next processing unit. Furthermore, the control unit 100 repeats the processing shown in FIGS. 9A and 9B until the processing is executed for all processing units included in the image data.

In this embodiment, the order of multi-valued density data after correction, which is used to update the condensing level parameter of ink, is decided in accordance with the printing direction of the image. Hence, in this embodiment, correction of the multi-valued density data used to relax a density change caused by the ink condensing in the nozzles can appropriately be executed in accordance with the printing direction of the image. As a result, in this embodiment, the updated condensing level parameter of ink can be made closer to the actual ink condensing state, and the correction accuracy of the multi-valued density data of the image data based on the ink condensing level can be improved. For this reason, the density of the finally printed image can be made substantially equal to that in a state in which no ink condensing occurs, and image quality can be improved.

In this embodiment, since whether ink is to be discharged or not is determined based on the multi-valued density data after correction, which is corrected by the condensing level parameter, it is possible to more correctly determine whether ink is to be discharged or not. Hence, in this embodiment, the condensing level parameter to be updated depending on whether ink is discharged or not can more accurately be updated.

In this embodiment, the order of multi-valued density data after correction is not changed in the forward path, and the order of multi-valued density data after correction is reversed in the backward path. Hence, in this embodiment, it is possible to implement the above-described effects with little increase in burden of processing in the backward path.

In this embodiment, an example in which the printing direction of the image is acquired as the printing condition has been described. However, the printing direction to be acquired is not limited to this. For example, when information representing whether to execute preliminary discharge before the start of scanning or the scanning speed at the time of image printing is acquired, the estimation accuracy of the ink condensing level improves, as a matter of course.

Also, in actual correction processing, the processing direction may be switched between image printing in the forward direction and image printing in the backward direction. When processing of reversing image data in the left-and-right direction is performed in advance for the pixels of a row in which the image is printed in the backward direction, the whole image can be processed in the same direction as the forward direction.

That is, regardless of whether the direction of correction is changed each time or whether image data is reversed in the left-and-right direction each time, actual correction processing is performed by completing the processing as one independent module, as described above. For this reason, time required for designing and confirming the image processing unit can be reduced not by preparing two types of processing but by reversing image data each time.

In this embodiment, the deviation amount of each ink color may be taken into consideration. For example, if a plurality of nozzle arrays are arranged along the scanning direction in accordance with the number of ink colors, the start position and the end position to printing of the nozzle array of each ink color in each band are deviated in accordance with the position of the nozzle array. Hence, the discharge position of each multi-valued density data needs to be adjusted in accordance with the deviation amount. Hence, in this embodiment, the discharge position of image data may be adjusted by adjusting and setting the band and the processing unit in accordance with the deviation amount of the nozzle array, and correction processing, change processing, and updating processing may be executed based on the processing unit. Note that the deviation amount of the nozzle array may be included in printing conditions and acquired together with other printing conditions.

### Second Embodiment

In the first embodiment, an example in which in 1-pass bidirectional printing of completing printing of corresponding image data by one print scanning while reciprocally scanning the printhead, the printhead is scanned up to the end portion of a print medium has been described.

In this embodiment, ink condensing level parameter estimation and an image data correction method in a case where the printhead is not scanned up to the end portion of a print medium will be described.

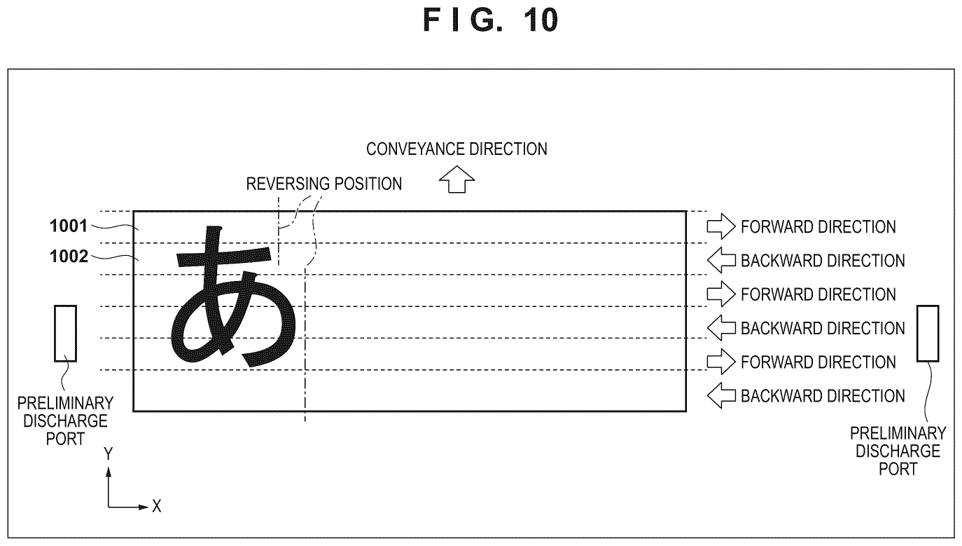

FIG. 10 is a view for explaining the reversing position of a printhead when printing an image on a print medium wider than the image shown in FIG. 4. In FIG. 10, the +X direction is the right direction, and the −X direction is the left direction.

By the printhead, the image of a band 1001 is printed on the print medium in the forward direction, and the image of a band 1002 immediately under the band 1001 is printed on the print medium in the backward direction. If the image and the print medium have widths as shown in FIG. 10, the printhead prints the image data of the band 1001, then stops at the reversing position shown in FIG. 10, conveys the print medium, and after that, prints the band 1002 from that position in the backward direction. This makes it possible to print two bands in a shorter time as compared to scanning up to the print medium end portion on the right side. Hence, in this embodiment, the printhead is stopped and reversed at the reversing position shown in FIG. 10.

As shown in FIG. 10, an inkjet printing apparatus described in this embodiment includes preliminary discharge ports configured to store preliminarily discharged ink outside the left and right ends of the print medium. The inkjet printing apparatus discharges condensed ink by preliminary discharge, thereby performing maintenance by preliminary discharge to return the ink condensing level to a standard state.

In the first embodiment, the above-described maintenance by preliminary discharge is performed in each print scanning, thereby regarding that the ink condensing level changes to the standard state. At the start of print scanning after the preliminary discharge, the ink condensing level is reset to zero. In this embodiment, after printing of the band 1001, print scanning of the band 1002 is performed without performing preliminary discharge. Hence, it is necessary that the ink condensing level parameter after printing of the band 1001 is not reset, and is taken over as an initial value to estimate the ink condensing level parameter of the band 1002.

Also, in the first embodiment, estimation of the ink condensing level parameter and correction processing of image data are performed from the image data left end portion in the right direction (X direction) in a case of image printing in the forward direction and from the image data right end portion in the left direction (−X direction) in a case of image printing in the backward direction. However, in this embodiment, the image data is folded back at the reversing position, as shown in FIG. 10. For this reason, in the band 1002, estimation of ink condensing level parameter and correction processing of multi-valued density data of image data, or the like need to be performed not from the right end portion of the print medium but from the reversing position as the start point.

In the inkjet printing apparatus according to this embodiment, when performing estimation of the ink condensing level parameter and correction processing of image data by reversing the order of printing of the multi-valued density data of the image data in the backward path, the same effects as described above can be obtained by performing reversal while regarding the section from the left end portion to the reversing position as the width of the original image.

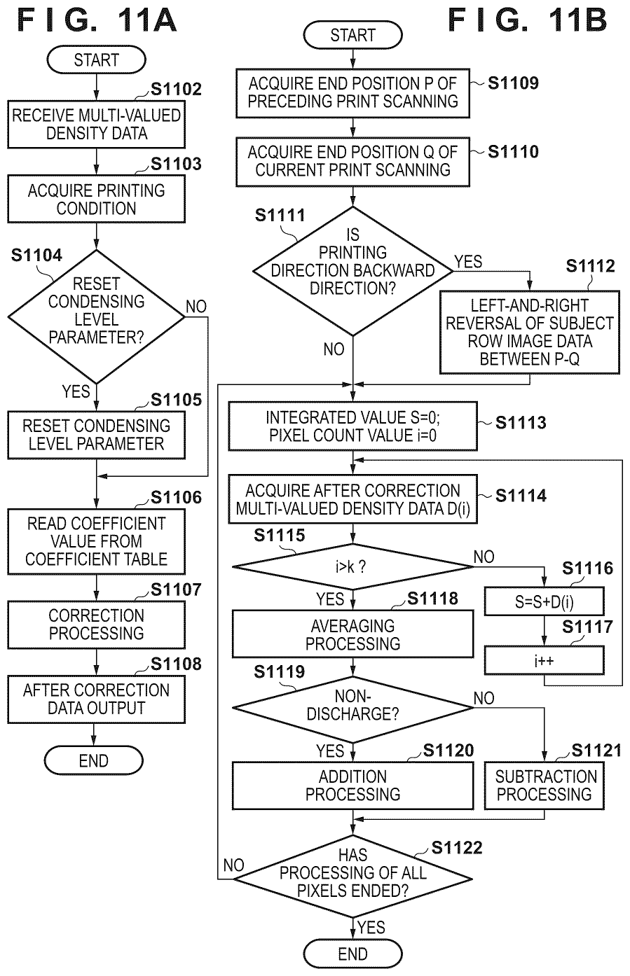

FIGS. 11A and 11B are flowcharts for explaining correction processing of multi-valued density data according to this embodiment.

FIG. 11A shows the same procedure as in the first embodiment, and a detailed description thereof will be omitted. In this embodiment, preliminary discharge is sometimes not performed immediately before image printing in the backward direction, as described above, based on the printing condition acquired in step S1103. In this case, when determining, in step S1104, whether preliminary discharge is executed immediately before, it is determined that preliminary discharge is not executed. Hence, the condensing level parameter is not cleared in step S1105, and the process advances to step S1106 to take over the condensing level parameter in the preceding print scanning.

In FIG. 11B, concerning change processing of multi-valued density data and updating processing of the condensing level parameter, differences from the first embodiment will be described. First, in step S1109, a control unit 100 acquires an end position P that is the position of the printhead at the end of preceding print scanning. For example, the end position P in the band 1002 shown in FIG. 10 is the reversing position in the preceding band 1001, and this is a position on the left side of the paper center indicated by an alternate long and short dashed line. Next, in step S1110, the control unit 100 acquires an end position Q of current print scanning. In printing of the band 1002, scanning is performed in the backward direction from the end position P described above, and printing is ended at the left end portion of the print medium. Hence, the end position Q of print scanning of the band 1002 is the left end portion of the print medium.

Here, in the band 1002, printing of the image data is ended at a positive position with respect to the origin in the X direction. The preliminary discharge port on the left side of the end position of print scanning of the image data is located closer than the preliminary discharge port on the right side. In this case, the control unit 100 moves the printhead to the preliminary discharge port on the left side after the end of printing of the image data. The control unit 100 may decide at which point the reversal is to be performed generally considering the width of the image and the distance from the preliminary discharge port or time without preliminary discharge and the influence on the printing time. In this embodiment, an example in which the control unit 100 acquires the information of the reversing position decided by a parameter determined in the image processing apparatus in advance will be described.

Upon determining, in step S1111, that the printing direction is the backward direction, in step S1112, the control unit 100 reverses the order of multi-valued density data of the image data. Here, since the start point for estimating the ink condensing level parameter is the end position P of preceding print scanning, the image data is reversed in the left-and-right direction not with respect to the left end that is the end portion of the band 1002 in the −X direction and the right end that is the end portion in the +X direction but with respect to the end position P of preceding print scanning and the end position Q of current print scanning. In other words, the control unit 100 reverses the order of multi-valued density data while setting the end position P of preceding print scanning to the start position for estimating the condensing level parameter and the end position Q of current print scanning to the end position for estimating the condensing level parameter.

The above-described points are different from the first embodiment. Steps S1113 to S1122 from then on are the same as in the first embodiment.

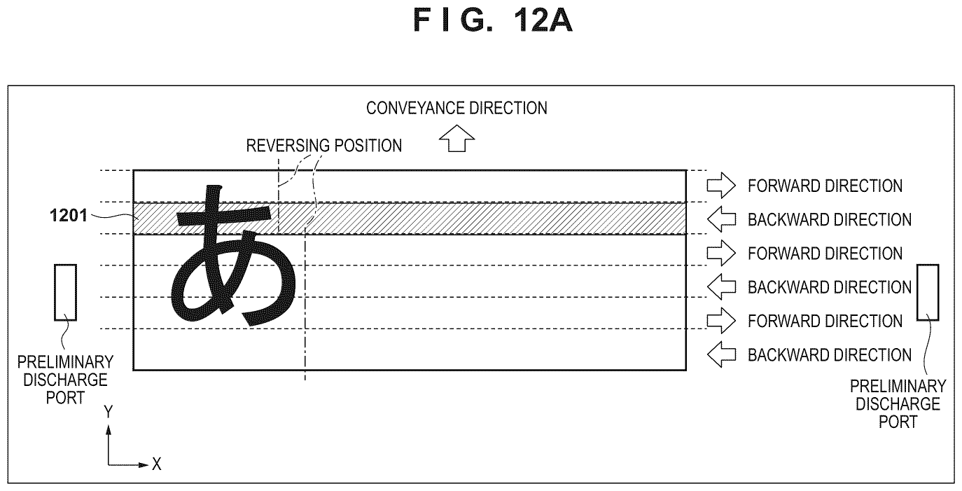

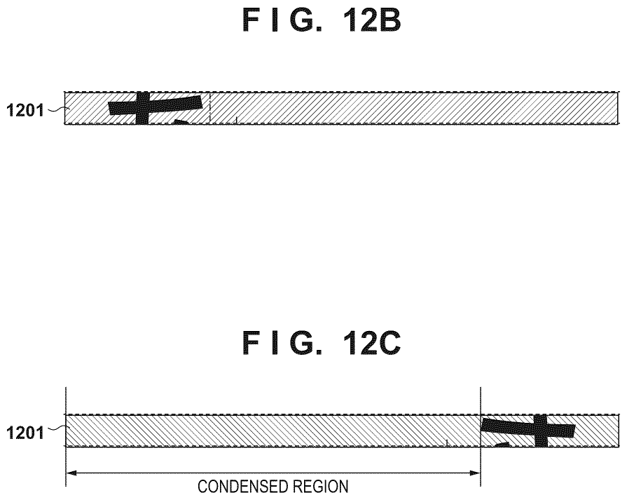

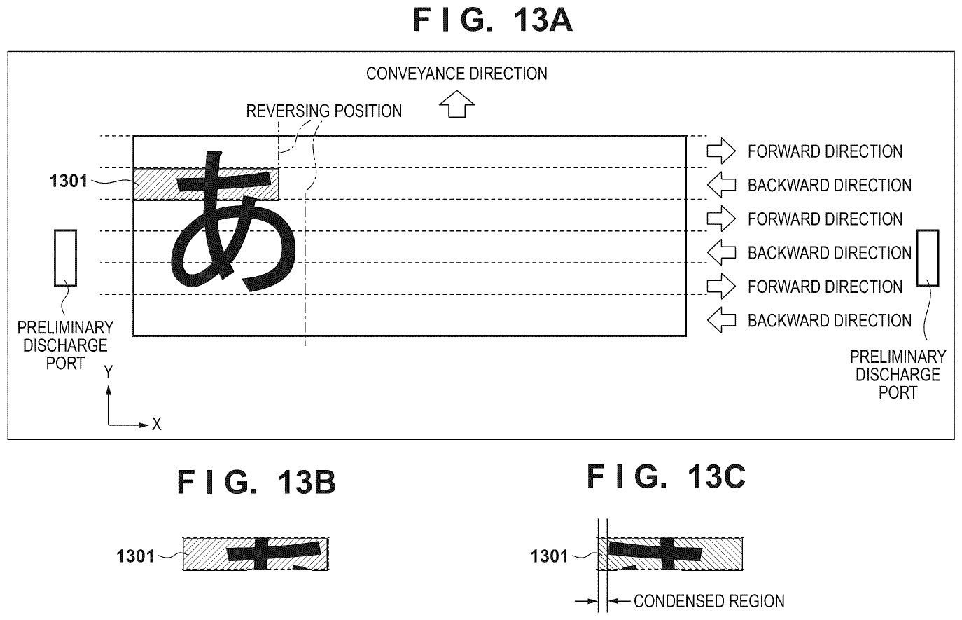

The effect of this processing will be described with reference to FIGS. 12A to 12C and 13A to 13C. FIGS. 12A to 12C are views for explaining a state in which the image is reversed at the two end portions of the print medium in the scanning direction of the printhead. The two end portions of the print medium in the scanning direction are the left end (that is, the −X end) and the right end (that is, the +X end).

FIG. 12A is a view showing the print medium in full width in a state in which an image including a plurality of bands 1201 is printed. In FIG. 12A, the range from the left end to the right end of the band 1201, that is, the region of the full width of the print medium in the X direction is indicated by hatching for the sake of simplifying the description. FIG. 12B shows the range of the band 1201 shown in FIG. 12A, which is cut out in the full width of the print medium, and FIG. 12C shows the range in FIG. 12B, which is reversed in the left-and-right direction.

Similarly, FIGS. 13A to 13C are views showing a state in which concerning the image, the start position of the forward path (that is, the left end or the end portion in the −X direction) and the reversing position in the scanning direction are reversed in accordance with the scanning range. FIG. 13B shows a band 1301 shown in FIG. 13A, which is cut out in the full width of the scanning range, and FIG. 13C shows the range in FIG. 13B, which is reversed in the left-and-right direction.

As is apparent from comparison of FIGS. 12C and 13C, the actual condensed region from the reversing position of the printhead cannot correctly be reflected in FIG. 12C, and the condensed region from the reversing position is correctly reflected in FIG. 13C. As described above, as show in FIGS. 13A to 13C, in this embodiment, reversal in the left-and-right direction is performed with respect to the position P at the end of preceding print scanning and the position Q at the end of current print scanning. As compared to a case where reversal is performed with respect to the left end and the right end of image data, the actual ink condensing level can more correctly be estimated, and the correction accuracy of the final image printing result can be improved.

Also, in this embodiment, since the control unit 100 can know the reversing position of the printhead by acquiring the printing condition, whether preliminary discharge is executed immediately before can be known. Note that the control unit 100 may more directly acquire information representing whether to execute preliminary discharge at the end of immediately preceding scanning.

At any rate, the control unit 100 can improve the estimation accuracy of the ink condensing level parameter based on information representing whether preliminary discharge is executed immediately before, and make the density of the final printed image close to a state with little influence of ink condensing.

In this embodiment, the reversing position is estimated for image data of one ink color. In many color inkjet printing apparatuses, the reversing position of the printhead is decided based on, in image data including a plurality of ink colors, for example, ink colors C, M, Y, and K, the position of image data existing at the most end in the direction of print scanning and the physical positions of nozzle arrays that discharge the ink colors C, M, Y, and K in the printhead. The distance from the reversing position to the start point of the image data in scanning changes depending on the deviation amounts of the nozzle arrays. These deviations can be absorbed by changing the initial value of the condensing level estimation parameter or providing an offset for each color in a threshold for determining discharge and non-discharge. Also, for example, a density correction unit 601 may adjust and set the processing unit in accordance with the deviation amounts of the nozzle arrays.

Also, for the purpose of absorbing the deviation amount in the Y direction (conveyance direction) for each color or preventing permanent matching with a nozzle that is in charge of discharge of the image data, the relationship between a nozzle and image data may be shifted for each color, the relationship between a nozzle and image data may be shifted for each page, or both the measures may be taken. These parameters may be acquired in the above-described printing condition acquisition step and reflected on image processing according to this embodiment.

### Third Embodiment

In the first and second embodiments, an example in which, in 1-pass printing in which printing of corresponding image data is completed by one print scanning, ink condensing level estimation and image data correction are performed in a case where image data is printed in both the forward and backward directions has been described.

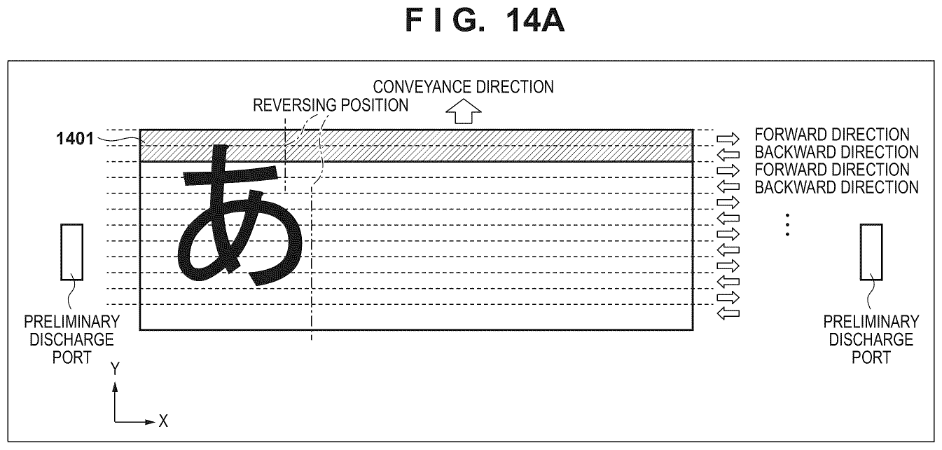

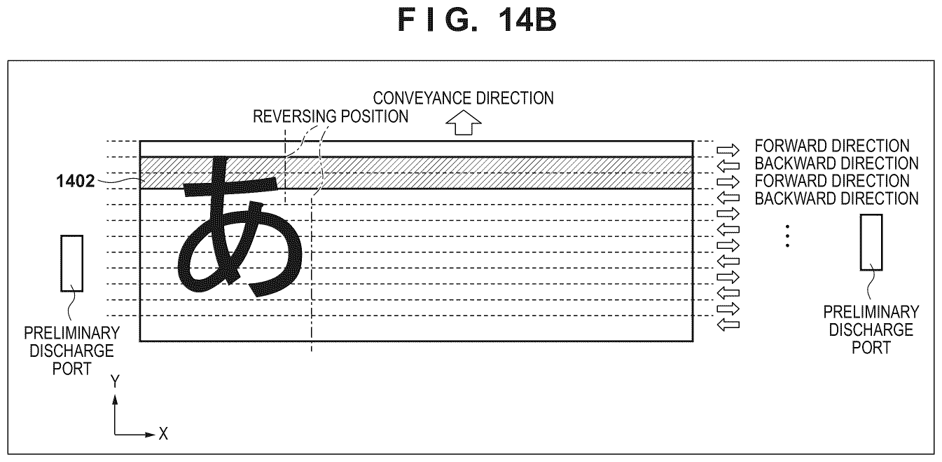

In the third embodiment, a method of estimating an ink condensing level and correcting image data in a case where the number of print passes is 2 or more will be disclosed. FIGS. 14A and 14B show an example of image printing by 2-pass bidirectional printing.

FIG. 14A shows first print scanning, and a hatching portion 1401 indicates a region printed by the first print scanning. Similarly, FIG. 14B shows second print scanning, and a hatching portion 1402 indicates a region printed by the second print scanning.

Here, the hatching portion 1401 is printed in the forward direction, and the hatching portion 1402 is printed in the backward direction. Since the image is printed by two scanning operations for the hatching portion 1401 and the hatching portion 1402, printing is performed in both the forward direction and the backward direction. For this reason, to correctly perform correction processing of multi-valued density data of the image, first, a control unit 100 corrects the multi-valued density data of the image data by correction processing in the forward direction for the hatching portion 1401. For the corrected image data, the control unit 100 then needs to correct the multi-valued density data of the image data by correction processing in the backward direction for the hatching portion 1402 at a position shifted by the conveyance amount of the print medium. Note that the multi-valued density data corrected in the hatching portion 1401 is printed by nozzles at positions shifted by the conveyance amount of the print medium.

FIGS. 14A and 14B show an example of 2-pass bidirectional printing. If the number of passes increases, the number of times of print scanning increases. Hence, burden of estimation of the ink condensing level parameter and correction processing of multi-valued density data of image data is enormous, as a matter of course. For this reason, to simplify processing, correction processing in the forward direction is executed once for entire image data, and correction processing in the backward direction is executed once of the image data after execution. This makes it possible to easily execute estimation of the ink condensing level and correction of image data.

In this embodiment, to simplify processing, the correction accuracy of multi-valued density data of image data is lowered a little. Whether to execute simply correction in consideration of the calculation load in correction processing and the actual correction accuracy or execute correction by a more correct method is selected from the viewpoint of required accuracy and the image printing speed.

As described above, according to this embodiment, even in bidirectional image printing in which printing is executed using a larger number of passes, image data correction can be more suitably be performed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-195293, filed Nov. 16, 2023, which is hereby incorporated by reference herein in its entirety.

What is claimed is:

1. An image processing apparatus for correcting image data used to print an image on a print medium by discharging ink from a plurality of nozzles provided in a printhead in scanning in each of a first direction included in a scanning direction crossing a conveyance direction of the print medium and a second direction different from the first direction, comprising
a correction unit configured to perform correction for, in the image data, image data to be printed by scanning in the first direction in accordance with a degree of condensing of the ink in the nozzles such that a density change caused by the condensing is relaxed, and perform, for image data to be printed by scanning in the second direction in the image data, correction different from the correction for the image data to be printed by the scanning in the first direction.

2. The apparatus according to claim 1, wherein
the image data is multi-valued density data,
the correction unit comprises an updating unit configured to execute correction processing of correcting first multi-valued density data of the image data in accordance with the degree of condensing and generating second multi-valued density data, execute change processing of changing an order of the second multi-valued density data in accordance with the scanning direction, and execute updating processing of updating a condensing level parameter indicating the degree of condensing of the ink based on the second multi-valued density data whose order is changed, and
the updating unit updates the condensing level parameter based on a result of determining, based on the second multi-valued density data, whether the ink is discharged from the plurality of nozzles.

3. The apparatus according to claim 2, wherein
the updating unit acquires a printing condition including information of the first direction and the second direction.

4. The apparatus according to claim 2, wherein
the updating unit repetitively updates the condensing level parameter.

5. The apparatus according to claim 2, wherein
the updating unit maintains the order of the second multi-valued density data in one of the first direction and the second direction, and reverses the order of the second multi-valued density data in the other direction.

6. The apparatus according to claim 2, wherein
in both the first direction and the second direction, the updating unit updates the condensing level parameter based on the second multi-valued density data by the same updating processing.

7. The apparatus according to claim 2, wherein
the correction unit and the updating unit execute the correction processing, the change processing, and the updating processing based on a processing unit according to the number of the plurality of nozzles arrayed in the conveyance direction, and repeat the correction processing, the change processing, and the updating processing up to an end portion on an end side of the image in the conveyance direction.

8. The apparatus according to claim 2, wherein
the printhead includes a plurality of nozzle arrays including the plurality of nozzles and arranged along the scanning direction, and
the correction unit and the updating unit execute the correction processing, the change processing, and the updating processing based on a processing unit set in correspondence with deviation amounts of the plurality of nozzle arrays in the scanning direction.

9. The apparatus according to claim 2, wherein
the updating unit changes the order of the second multi-valued density data to be used to correct the condensing level parameter based on a reversing position of the printhead in the scanning direction.

10. The apparatus according to claim 9, wherein
the updating unit reverses the order from the second multi-valued density data of a pixel closest to the reversing position.

11. The apparatus according to claim 2, wherein
in a case where preliminary discharge of discharging the ink outside the print medium is executed, the correction unit resets the condensing level parameter and corrects the second multi-valued density data.

12. The apparatus according to claim 11, wherein
in a case where the preliminary discharge is not executed when switching a direction of the printhead between the first direction and the second direction, the correction unit maintains the condensing level parameter and corrects the second multi-valued density data.

13. An image processing method of correcting image data used to print an image on a print medium by discharging ink from a plurality of nozzles provided in a printhead in scanning in each of a first direction included in a scanning direction crossing a conveyance direction of the print medium and a second direction different from the first direction, comprising
performing correction for, in the image data, image data to be printed by scanning in the first direction in accordance with a degree of condensing of the ink in the nozzles such that a density change caused by the condensing is relaxed, and performing, for image data to be printed by scanning in the second direction in the image data, correction different from the correction for the image data to be printed by the scanning in the first direction.

14. A non-transitory computer-readable storage medium storing a computer program that, when read and executed by a computer for correcting image data used to print an image on a print medium by discharging ink from a plurality of nozzles provided in a printhead in scanning in each of a first direction included in a scanning direction crossing a conveyance direction of the print medium and a second direction different from the first direction, causes the computer to function as
a correction unit configured to perform correction for, in the image data, image data to be printed by scanning in the first direction in accordance with a degree of condensing of the ink in the nozzles such that a density change caused by the condensing is relaxed, and perform, for image data to be printed by scanning in the second direction in the image data, correction different from the correction for the image data to be printed by the scanning in the first direction.
